(19) United States
(12) Patent Application Publication
(10) Pub. No.: US 2015/0109261 A1
(43) Pub. Date: Apr. 23, 2015

(54) PROJECTION APPARATUS

(71) Applicant: Makoto MASUDA, Nara-shi (JP)

(72) Inventor: Makoto MASUDA, Nara-shi (JP)

(21) Appl. No.: 14/516,144

(22) Filed: Oct. 16, 2014

(30) Foreign Application Priority Data
Oct. 18, 2013 (JP) 2013-217042

(51) Int. Cl. G06F 3/042

(52) U.S. Cl. CPC G06F 3/0421
USPC 345/175

(57) ABSTRACT

A projection apparatus includes light source modules (a first light source module, and a second light source module) equipped with a laser light source emitting a laser beam, a light deflection unit configured to perform a two-dimensional scanning with the laser beam emitted from the light source module and project a projection image on an image projection surface, a light detection unit configured to detect a reflection light beam of the laser beam from an operation executor on the projection image, and a control unit configured to determine a position of the projection image with which the operation executor is in contact based on information from the light detection unit and information from the projection image.

### CROSS REFERENCE TO RELATED APPLICATION

This application is based upon and claims the benefit of priority from Japanese patent application No. 2013-217042, filed on Oct. 18, 2013, the disclosure of which is incorporated herein in its entirety by reference.

### TECHNICAL FIELD

The present invention relates to a projection apparatus.

### BACKGROUND ART

There is known a projection apparatus which makes laser beams of three primary colors (red, green, and blue) converged into one laser beam and performs a two-dimensional scanning onto an image projection surface to form a projection image, and detects a relative positional relation between an operation executor existing in the projection image and the projection image. For example, JP 2006-323866 A discloses an apparatus in which a finger or the like as an operation executor is placed on a projected keyboard image or mouse image, and the movement of the finger is captured by a scanning sensor to be detected as operation position information with respect to the projection image. Further, JP 2004-523031 W discloses an apparatus in which light is emitted from an illumination system to a finger or the like as an operation executor placed on a projection image, and scattered light or reflected light from the operation executor is detected by a light detection unit to detect a position of the operation executor with respect to the projection image.

### SUMMARY OF INVENTION

### Technical Problem

In such a projection apparatus, it is possible to determine a position of the finger on a projection plane, but whether or not the finger is in contact with the projection plane is hardly determined. In the projection apparatus described in JP 2006-323866 A and JP 2004-523031 W, the movement of the finger is determined by image processing, and the accuracy is poor in detecting that the operation executor is in contact with the image projection surface. Accordingly, it is difficult to accurately detect a position at which the operation executor is in contact with the image projection surface. It is preferable that the operation not be executed only by placement of the finger or the like near the operation target. In other words, it is preferable that the operation be executed after when a behavior such as pressing the operation target by the finger or the like is reliably accompanied from the position.

The invention has been made in view of the above circumstances, and an object thereof is to provide a projection apparatus which can accurately detect a contact position of an operation executor on a projection image with respect to the image projection surface.

### Solution to Problem

In order to solve the above-mentioned problems, the invention provides a projection apparatus including light source module which includes a laser light source to emit a laser beam; a light deflection unit configured to perform a two-dimensional scanning with the laser beam emitted from the light source module and project a projection image on an image projection surface; a light detection unit configured to detect a reflection light beam of the laser beam from an operation executor on the projection image; and a control unit configured to determine a position of the projection image with which the operation executor is in contact, based on information from the light detection unit and information from the projection image.

Further, in addition to the above invention, the light source module may include any one or all of a red laser light source, a green laser light source, and a blue laser light source.

Further, in addition to the above invention, the laser light source may include a plurality of laser light sources which emit laser beams different in wavelength according to an image signal, the light source module may be configured to synthesize and emit the laser beams emitted from the plurality of laser light sources, and the light detection unit may be an image capture unit which images the operation executor.

Further, in addition to the above invention, the projection apparatus may be configured to detect a contact position between the operation executor and the image projection surface by the light detection unit, and detect a position of the operation executor with respect to the projection image in association with the contact position and drawing line information of the laser beam.

Further, in addition to the above invention, the light deflection unit may have a MEMS structure of an electrostatic drive system in which a mirror unit and a mirror driving unit to oscillate the mirror unit are included.

Further, in addition to the above invention, the projection apparatus further includes a combining light source module which can emit the laser beam and used in combination with the light source module; and a multiplexing unit configured to synthesize a laser beam emitted from the light source module and a laser beam emitted from the combining light source module.

Further, in addition to the above invention, the laser beam may include an infrared beam, and the infrared beam may be constantly irradiated within the area of the projection image.

Further, in addition to the above invention, the projection image may be an operation pattern of an operation target device.

Further, in addition to the above invention, the projection apparatus further includes, in addition to the light detection unit, a second light detection unit which is disposed near the image projection surface and configured to detect movement of the operation executor in a vertical direction with respect to the image projection.

### BRIEF DESCRIPTION OF DRAWINGS

FIG. 1 is a diagram schematically illustrating a projection apparatus according to a first embodiment of the invention;

FIG. 2 is a diagram illustrating a schematic configuration of a light source unit according to the first embodiment;

FIG. 3 is a diagram illustrating a schematic configuration of a first light source module according to the first embodiment;

FIG. 4 is a diagram illustrating a schematic configuration of a first light source module according to a modified example of FIG. 3;

FIG. 5 is a diagram illustrating an example of a schematic configuration of a second light source module according to the first embodiment;

FIG. 6 is a plan view illustrating an example of a configuration of a light deflection unit according to the first embodiment;

FIG. 7 is a diagram illustrating a scan image in the case of a raster scan;

FIG. 8 is a diagram illustrating a scan image in the case of a Lissajous scan;

FIG. 9 is a block diagram illustrating the main configuration of a control unit according to the first embodiment; and

FIG. 10 is a diagram schematically illustrating a projection apparatus according to a second embodiment of the invention.

### DESCRIPTION OF EMBODIMENTS

Hereinafter, a projection apparatus according to embodiments of the invention will be described with reference to the drawings. The projection apparatus to be described below relates to a projection apparatus which forms a projection image by performing a scanning with a laser beam according to an image signal, and detects a position of an operation executor such as a finger in relation to the projection image.

### First Embodiment

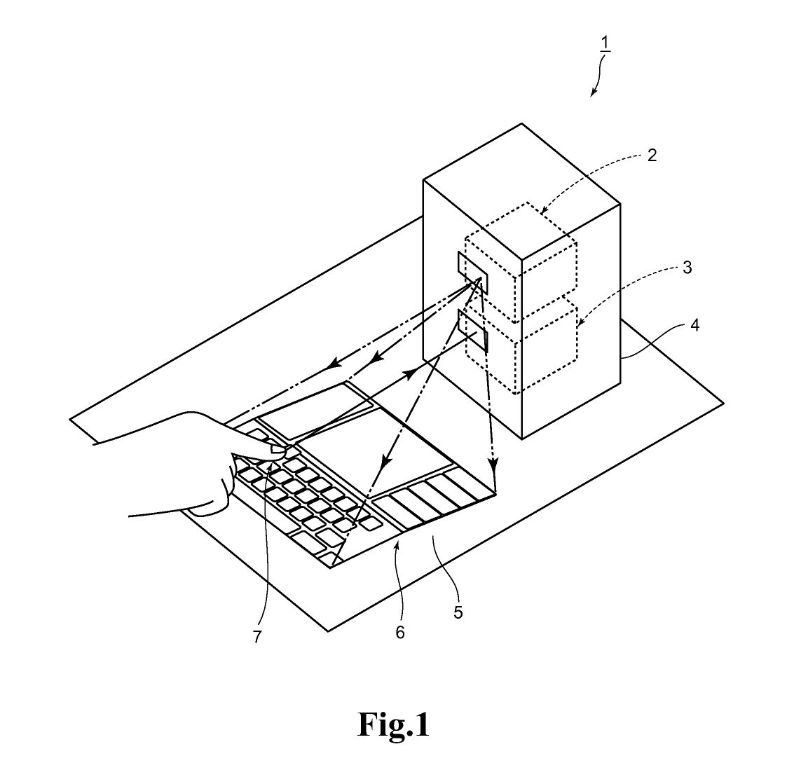

FIG. 1 is a diagram schematically illustrating a projection apparatus 1 according to a first embodiment of the invention. The main components of the projection apparatus 1 are a light source unit 2 and an image capture unit 3 as a light detection unit. The light source unit 2 and the image capture unit 3 are attached inside a housing 4, and also vertically disposed along one side surface of the housing 4. The light source unit 2 is configured to emit a laser beam from an opening portion of the housing 4 toward an external image projection surface 5, and the image capture unit 3 is configured to receive a reflection light beam of the laser beam emitted from the opening portion of the housing 4.

FIG. 1 illustrates a projection apparatus as an embodiment in which a keyboard image (hereinafter, referred to as a keyboard image 6) as a projection image 6 is projected to the image projection surface 5, an image of a position and movement of a finger (hereinafter, referred to as a finger 7) as the operation executor 7 is captured by the image capture unit 3, and it is identified which key of the keyboard image 6 is operated (touch operation). Accordingly, in the embodiment, the mounting location of the projection apparatus 1 and the image projection surface 5 are assumed to be disposed together on a desk, the light source unit 2 is disposed at a position where the keyboard image 6 can be projected. Further, in the embodiment, the light source unit 2 is disposed in an upper part and the image capture unit 3 is disposed in a lower part.

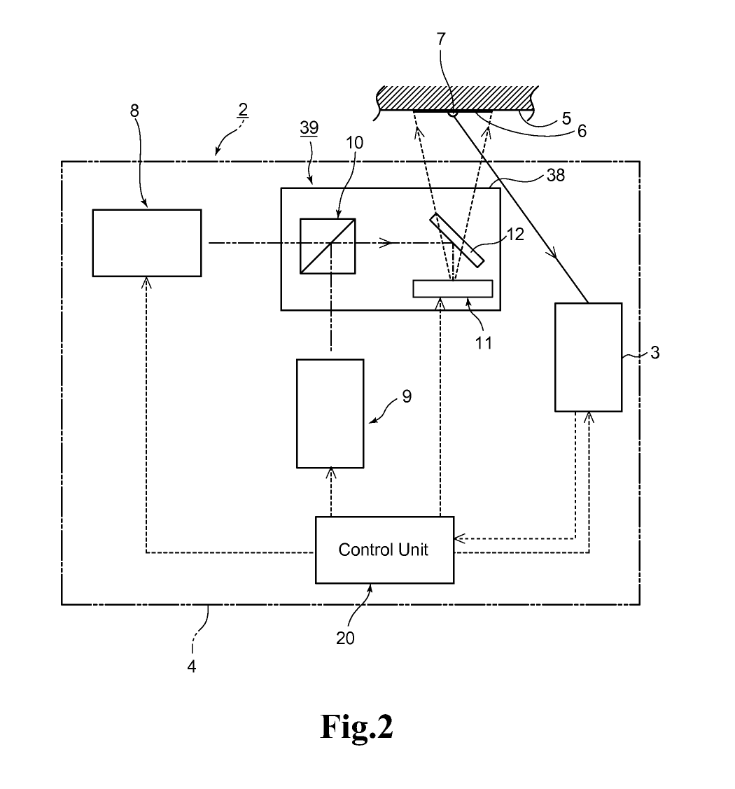

Next, the configuration of the light source unit 2 will be described with reference to FIG. 2. FIG. 2 is a diagram illustrating a schematic configuration of the light source unit 2. As illustrated in FIG. 2, the light source unit 2 includes two light source modules 8 and 9 configured to emit laser beams, a multiplexing unit 10 configured to synthesize the laser beams emitted from the light source modules 8 and 9 into one laser beam, and a light deflection unit 11 configured to perform a two-dimensional scanning with the laser beam according to an image signal to project the projection image 6 on the image projection surface 5. In the embodiment, an optical element 12 is provided between the light deflection unit 11 and the image projection surface 5. In addition, the light source modules 8 and 9 will be denoted by a first light source module 8 and a second light source module 9 in order to make a distinction therebetween.

When the first light source module 8 is used as a main light source module, the second light source module 9 serves as a combining light source module which may be used in combination with the first light source module 8 according to applications. Therefore, the second light source module 9 is not necessarily provided in some cases. Further, a third light source module may be additionally provided.

The image capture unit 3 as the light detection unit is, for example, a CCD camera, and can detect a reflection light beam from the finger 7 as the operation executor. As the light detection unit, in addition to the CCD camera, a photo sensor or the like may be used.

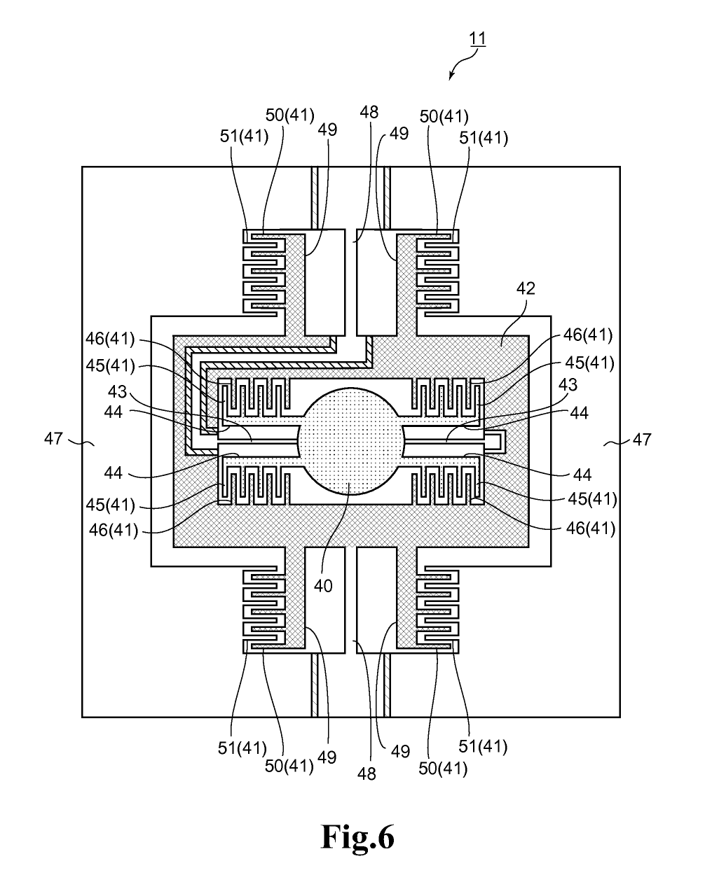

Further, the projection apparatus 1 includes a control unit 20 as illustrated in FIG. 2 in addition to the above-mentioned optical elements. The control unit 20 serves to drive the first light source module 8, the second light source module 9, the light deflection unit 11, and the image capture unit 3 and controls a detection operation. The light deflection unit 11 is provided with a mirror unit and a mirror driving unit which oscillates the mirror unit, and the detailed configuration will be described below with reference to FIG. 6.

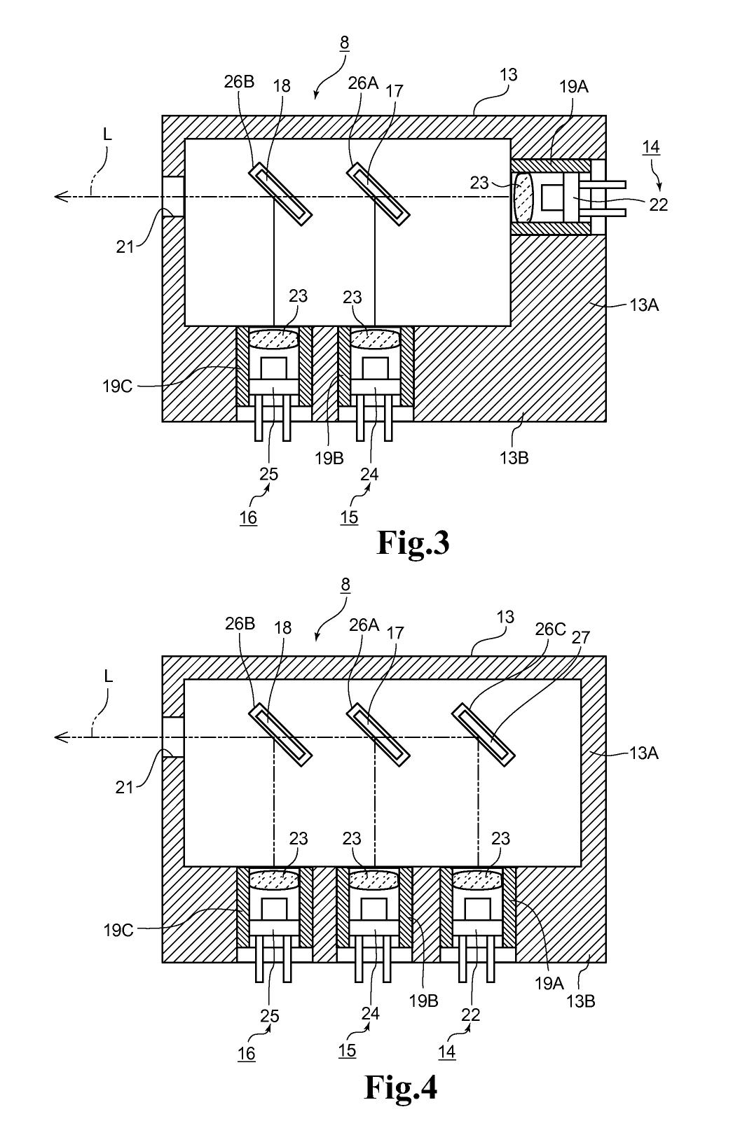

Next, the first light source module 8 will be described. FIG. 3 is a diagram illustrating a schematic configuration of the first light source module 8 and corresponds to a cross-sectional, plan view. As illustrated in FIG. 3, the first light source module 8 includes the housing 13, three laser light sources 14, 15, and 16, and dichroic mirrors 17 and 18. The housing 13 includes three light source attachment portions 19A, 19B, and 19C, and the laser light sources 14, 15, and 16, which respectively can emit laser beams having wavelengths of red, green and blue, are attached to the light source attachment portions 19A, 19B, and 19C.

In the configuration illustrated in FIG. 3, the light source attachment portion 19A is provided in a wall portion 13A of the housing 13 intersecting the extension of an optical axis L toward a circular light-emitting aperture 21 provided in housing 13. A red laser light source 22 which can emit a red laser beam and a collimator lens 23 are attached to the light source attachment portion 19A.

Further, the light source attachment portions 19B and 19C are provided in a wall portion 13B intersecting the wall portion 13A. Among them, the light source attachment portion 19B is provided at a position near the light source attachment portion 19A, and a green laser light source 24 which can emit a green laser beam and another collimator lens 23 are attached thereto. Further, the light source attachment portion 19C is provided at a position away from the light source attachment portion 19A farther than the light source attachment portion 19B, and a blue laser light source 25 which can emit a blue laser beam and the other collimator lens 23 are attached thereto. Each collimator lens 23 adjusts the laser beams emitted from the laser light source of the corresponding color to be a parallel light beam and emits the beam.

In addition, the red laser beam is a laser beam having a single wavelength in a range of 635 nm to 690 nm, and for example a laser beam having a wavelength of 640 nm is employed in the embodiment. Further, the green laser beam is a laser beam having a single wavelength in a range of 500 nm to 560 nm, and for example a laser beam having a wavelength of 515 nm is employed in the embodiment. Further, the blue laser beam is a laser beam having a single wavelength in a range of 435 nm to 480 nm, and for example a laser beam having a wavelength of 450 nm is employed in the embodiment. The laser light sources of these colors can be realized using laser diodes corresponding to the wavelengths of red, green, and blue.

Further, mirror attachment portions 26A and 26B are provided in the housing 13, and the dichroic mirrors 17 and 18 are attached to the mirror attachment portions 26A and 26B, respectively. In the embodiment, the dichroic mirror 17 which reflects the green laser beam but transmits the red laser beam and the like is attached on the optical axis of the green laser light source 24. In addition, the dichroic mirror 17 may be configured to transmit only the red laser beam. Further, the dichroic mirror 18 which reflects the blue laser beam having a wavelength shorter than the green light but transmits the laser beam having a wavelength of the green light and that longer than the green light is attached on the optical axis of the blue laser light source 25. In addition, the dichroic mirror 18 may be configured to reflect only the blue laser beam and transmit the other laser beams, or may be configured to transmit only the red and green laser beams and reflect the other laser beam.

Further, the configuration illustrated in FIG. 4 may be employed instead of the configuration illustrated in FIG. 3. FIG. 4 is a diagram illustrating a schematic configuration of the first light source module 8 according to a modified example of FIG. 3, and corresponds to a cross-sectional, plan view. In addition, the optical elements in the same relation as those in FIG. 3 are denoted by the same reference numerals, and the descriptions thereof will not be repeated.

For example, in a case where a region for providing an electrical connection of the first light source module 8 is restricted due to a spatial constraint of the projection apparatus 1, the configuration illustrated in FIG. 4 may be used. In the configuration illustrated in FIG. 4, the light source attachment portions 19A, 19B, and 19C are provided in the same wall portion 13B. Further, a mirror attachment portion 26C is newly provided in order to reflect the red laser beam emitted from the red laser light source 22 attached to the light source attachment portion 19A. A dichroic mirror 27 to reflect the red laser beam is attached to the mirror attachment portion 26C.

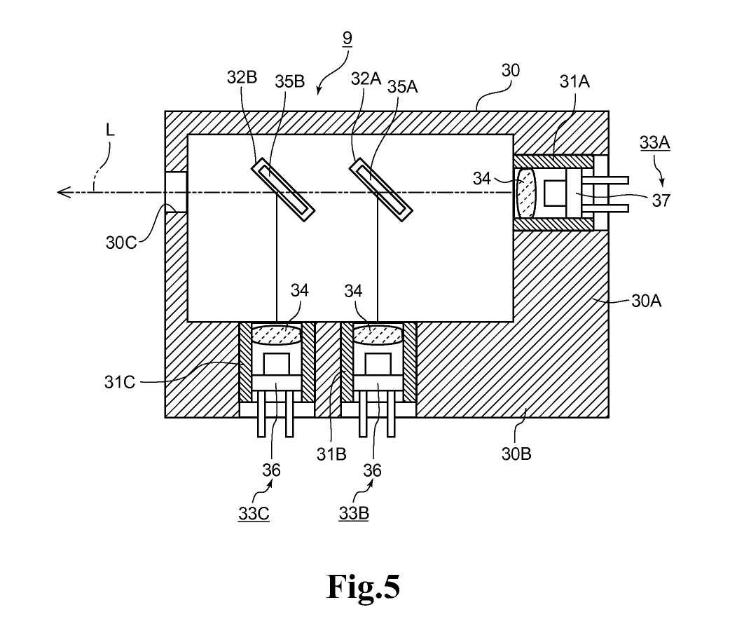

Next, the second light source module 9 corresponding to the combining light source module will be described. FIG. 5 is a diagram illustrating an example of a schematic configuration of the second light source module 9 and corresponds to a cross-sectional, plan view. In addition, basically, many parts of the second light source module 9 are configured in common with the first light source module 8. In other words, a housing 30 in the second light source module 9 has the same configuration with the housing 13 illustrated in FIG. 3. Further, the housing 30 includes light source attachment portions 31A, 31B, and 31C equal to the light source attachment portions 19A, 19B, and 19C provided in the housing 13, mirror attachment portions 32A and 32B equal to the mirror attachment portions 26A, and 26B, and a light-emitting aperture 30C equal to the light-emitting aperture 21.

However, laser light sources 33A, 33B, and 33C attached to the light source attachment portions 31A, 31B, and 31C of the housing 30 may be appropriately changed according to the applications of the projection apparatus 1. In other words, a laser light source which can emit an appropriate laser beam according to necessary chromaticity or brightness can be configured to be attached to any one of the light source attachment portions 31A, 31B, and 31C.

In addition, as the laser light sources 33A, 33B, and 33C, and three collimator lenses 34 illustrated in FIG. 5, those equal to the laser light sources 14, 15, and 16 and the respective collimator lenses 23 illustrated in FIG. 3 may be used or other types may be used as needed. Further, as dichroic mirrors 35A and 35B attached to the mirror attachment portions 32A and 32B, those equal to the dichroic mirrors 17 and 18 illustrated in FIG. 3 may be used or other types may be used as needed.

The following configuration may be given as an example of the laser light sources 33A, 33B, and 33C attached to the light source attachment portions 31A, 31B, and 31C. For example, in a case where an image is formed by synthesizing the laser beams, it is necessary to form the white light. The white light is formed by synthesizing the red, green, and blue laser beams at a predetermined ratio. However, though the amount of the blue laser beam is large, it does not contribute greatly to the improvement in brightness (illuminance).

As illustrated in FIG. 2, the laser beams emitted from the first light source module 8 and the second light source module 9 are multiplexed (synthesized) into one optical flux by the multiplexing unit 10. In this way, the laser beam after being emitted from the multiplexing unit 10 gains in illuminance compared to that emitted only from the first light source module 8. Therefore, in a case where the second light source module 9 includes, for example, a green laser light source 36, the brightness can be increased compared to the case where only the first light source module 8 is used.

Therefore, in the second light source module 9, a red laser light source 37 emitting the red laser beam and the green laser light source 36 emitting the green laser light may be provided without providing the blue laser light source emitting the blue laser beam. For example, in a case where the three laser light sources are disposed, all of them may be provided as the red laser light source 37, all of them may be provided as the green laser light source 36, or one or two red laser light sources 37 may be provided and the rest may be provided as the green laser light source 36.

In particular, the green laser light source 36 greatly contributes to the improvement in brightness. Therefore, on the contrary, in a case where the efficiency of the red laser light source 22 is made to be high in the first light source module 8, the white light can be formed in the second light source module 9 even by employing a configuration in which only the green laser light sources 36 are provided, or a configuration in which the green laser light sources 36 are provided more than the number of the red laser light sources 37.

In the configuration illustrated in FIG. 5, two green laser light sources 36 and one red laser light source 37 are provided in order to increase the brightness.

Further, the second light source module 9 may be configured such that infrared sensors having light sources which can emit infrared laser beams are attached instead of the red, green and blue laser light source. In addition, the infrared sensor further includes a light receiving unit which receives a reflection light beam (specular reflection light beam) of the emitted light. Through the light receiving operation, the light receiving unit is used to detect a position of the finger 7 (the operation executor) as a target in a vertical direction with respect to the image projection surface 5 and a position of the finger 7 in a two-dimensional direction with respect to the projection image 6. Meanwhile, other types of sensors besides the infrared sensor may be employed as the light detection unit. Examples of such a sensor include various types of sensors such as a photo diode of a light projection/reception system. When employing this configuration, the light source unit 2 may serve as the image capture unit 3.

In addition, there can be employed, if necessary, various types of laser light sources emitting laser beams such as a yellow laser beam, a blue-violet laser beam, a violet laser beam, an orange laser beam, and a laser beam in an ultraviolet region.

As described above, the second light source module 9 may be configured by combining various types of laser light sources according to a required (desired) brightness or a request for a product having another option. In other words, the second light source module 9 serves as a combining light source module with respect to the main first light source module 8.

As the multiplexing unit 10, a prism may be used. Besides the prism as the multiplexing unit 10, the optical element 12 such as a collective lens, a collimator lens, and a mirror may be disposed as needed. Further, a mirror may be used instead of the prism, and besides the mirror, the optical element 12 such as a collective lens, a collimator lens, and a mirror may be disposed as needed (only the mirror is illustrated as a representative configuration of the optical element 12 in FIG. 2).

As illustrated in FIG. 2, the laser beams emitted from the first light source module 8 and the second light source module 9 pass through the multiplexing unit 10, and, if necessary, pass through the optical element 12, and then are incident to the light deflection unit 11. In the configuration illustrated in FIG. 2, the multiplexing unit 10 and the light deflection unit 11 are integrally attached to a housing 38, and form one optical unit 39. However, the multiplexing unit 10 and the light deflection unit 11 may be configured to be individually adjusted in position without the attachment to the housing 38.

The light deflection unit 11 includes a mirror unit 40 as illustrated in FIG. 6. The mirror unit 40 is oscillated by the mirror driving unit 41 to be described below, so that the image projection surface 5 is scanned with the laser beam to form the projection image 6.

The light deflection unit 11 of the embodiment has a micro electro mechanical systems (MEMS) structure in which an actuator of an electrostatic drive system is included, and the configuration is illustrated in FIG. 6. FIG. 6 is a plan view illustrating an example of a configuration of the light deflection unit 11. The light deflection unit 11 illustrated in FIG. 6 includes an inner flame 42, the mirror unit 40 is disposed in an almost center portion of the inner side of the inner flame 42, and is supported on the both ends by the inner flame 42 through a torsional shaft 43. The mirror unit 40 is formed by depositing a reflective member such as silver on a wafer, and when the mirror unit 40 is formed, an appropriate material, a deposit thickness, and a configuration of deposit layers are determined according to a wavelength, an intensity, and a reflection efficiency of the laser beam.

The torsional shaft 43 is a shaft component which allows the inner frame 42 to oscillate and twist the mirror unit 40. Further, extension portions 44 are extended from the mirror unit 40 with the torsional shaft 43 interposed therebetween, and a plurality of mirror-side comb-like electrodes 45 are provided to protrude from the extension portion 44. The mirror-side comb-like electrodes 45 are alternately inserted into first comb-like electrodes 46 of the inner frame 42. The mirror driving unit 41 is configured by the mirror side comb-like electrodes 45 and the first comb-like electrodes 46. Any one side of the mirror-side comb-like electrodes 45 and the first comb-like electrodes 46 protrudes to the top surface or the bottom surface of the light deflection unit 11 compared to the other electrodes. Therefore, when a voltage is applied to the mirror side comb-like electrode 45 and the first comb-like electrode 46, and a torsional force is applied to the torsional shaft 43 by an attractive force and a repulsive force working therebetween, so that the mirror unit 40 can be oscillated (driven) about the torsional shaft 43 as a rotation shaft.

Further, the inner frame 42 is supported to an outer frame 47 through the torsional shaft 48 which can be twisted, and the same configuration as that between the mirror unit 40 and the inner frame 42 is provided also between the inner frame 42 and the outer frame 47. In other words, extension portions 49 are extended from the inner flame 42 with the torsional shaft 48 interposed therebetween, and second comb-like electrodes 50 are provided to protrude from the extension portions 49. The second comb-like electrodes 50 are alternately inserted into outer-frame-side comb-like electrodes 51 of the outer frame 47. One mirror driving unit 41 is configured by the second comb-like electrodes 50 and the outer flame side comb-like electrodes 51. Then, any one side of the second comb-like electrodes 50 and the outer-frame-side comb-like electrodes 51 protrudes from the top surface or the bottom surface of the light deflection unit 11 compared to the other electrodes. Therefore, when a voltage is applied to the second comb-like electrode 50 and the outer-frame-side comb-like electrode 51, and the torsional force is applied to the torsional shaft 48 by the attractive force and the repulsive force working therebetween, so that the mirror unit 40 can be oscillated (driven) about the torsional shaft 48 as a rotation shaft.

A period and a range of vibration of the mirror unit 40 can be set between the mirror-side comb-like electrode 45 and the first comb-like electrode 46, and between the second comb-like electrode 50 and the outer-frame-side comb-like electrode 51 according to the applied voltages. Then, in a case when a drive cycle of the mirror unit 40 is shortened, the drive cycle is desirable to be close a resonance frequency of the mirror unit 40. In the embodiment, the torsional shaft 43 relating to a main scanning is applied with a voltage of 120 V at 20 KHz, and the torsional shaft 48 relating to a sub scanning is applied with a voltage of 50 V at 60 Hz, so that the mirror unit is oscillated at twist angles of 40 degrees in a main scanning direction and of 20 degrees in a sub scanning direction. However, the configuration is not limited to these frequencies, voltages, and twist angles, but various other settings can be made.

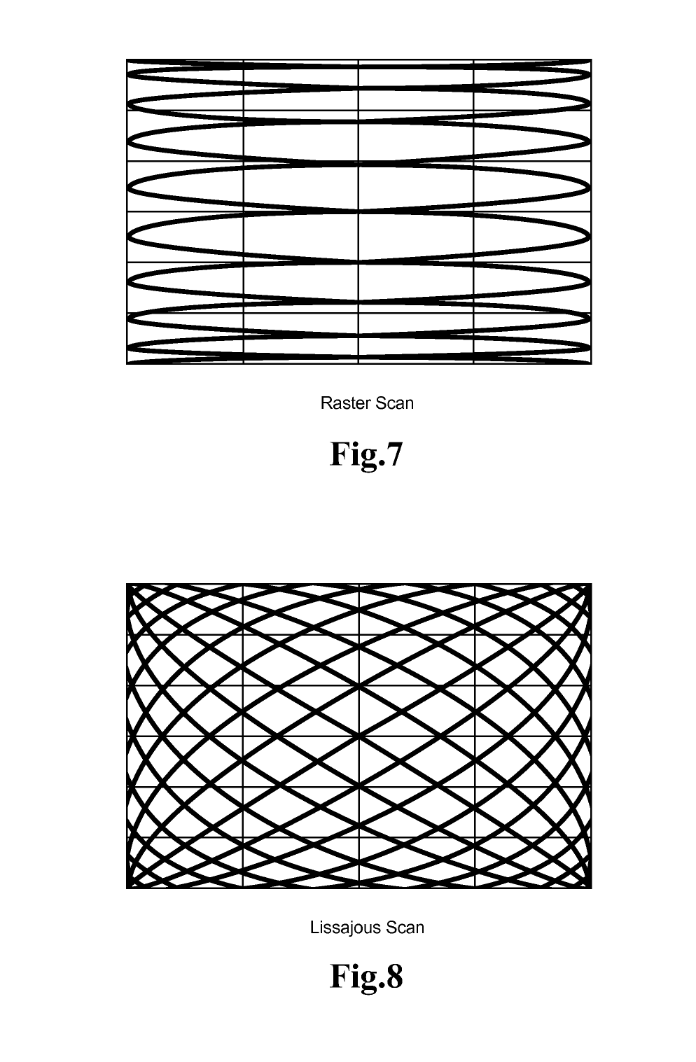

Further, the voltages applied to the respective comb-like electrodes 45, 46, 50, and 51 can be appropriately set according to a tracking property of the mirror unit 40 such as a trapezoid waveform or a sawtooth waveform besides the sine waveform. Then, the scanning is performed with the laser beam by a drive control of the mirror driving unit 41. As the scan method to form the projection image, two types of the methods are employed in many cases. FIG. 7 is a diagram illustrating a scan image in the case of a raster scan. Further, FIG. 8 is a diagram illustrating a scan image in a case of a Lissajous scan. In addition, in the raster scan, the sub scanning direction may not be the sine waveform but the sawtooth waveform. In a control system, information for forming such a scan image (scanning locus) is expressed as drawing line information.

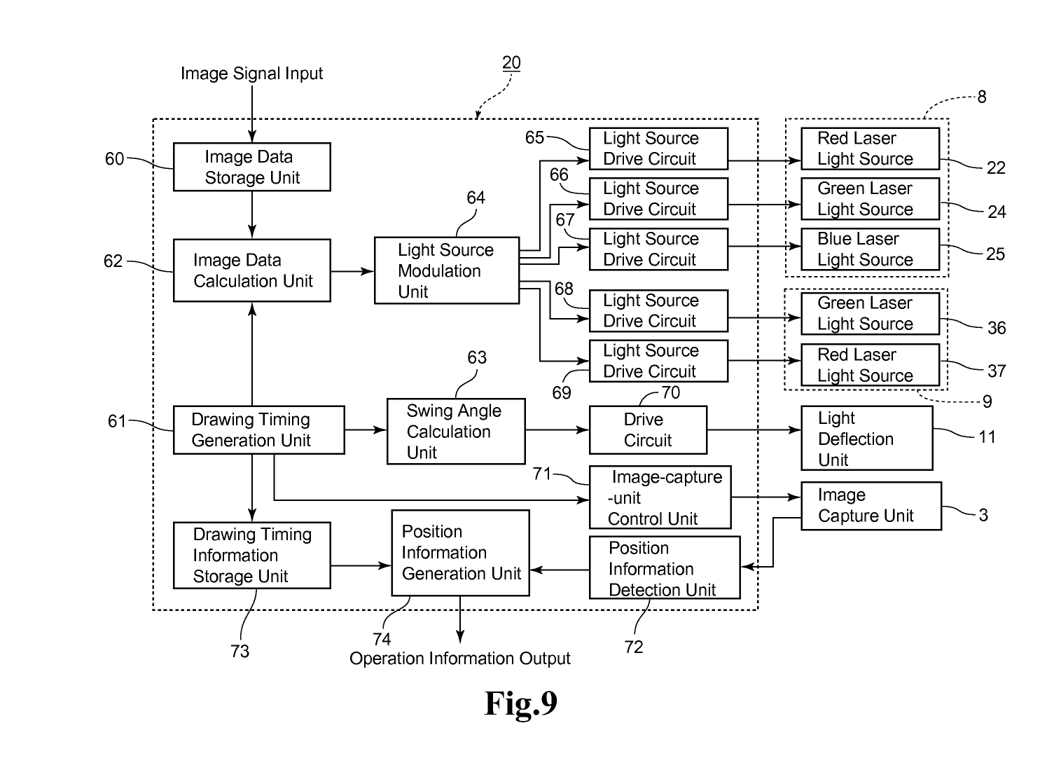

Further, as illustrated in FIG. 2, the projection apparatus 1 of the embodiment includes the control unit 20. The control unit 20 receives an image signal, and serves to drive the first light source module 8, the second light source module 9, the light deflection unit 11, and the image capture unit 3 and controls the detection operation. The configuration and operation of the control unit 20 will be described with reference to FIG. 9.

FIG. 9 is a block diagram illustrating a main configuration of the control unit 20 according to the embodiment. In addition, FIG. 9 illustrates an example of a case where the first light source module 8 described with reference to FIGS. 3 and 4, and the second light source module 9 described with reference to FIG. 5 are employed. The control unit 20 receives the image signal indicating image data, and temporarily stores the image data in an image data storage unit 60. A drawing timing generation unit 61 generates drawing timing information and drawing line information. Among them, the drawing timing information is sent out to an image data calculation unit 62, and the drawing line information is sent out to a swing angle calculation unit 63. The drawing timing information contains timing information and the like to be used for drawing an image. Further, the drawing line information contains information (two-dimensional scanning position information) of the scanning locus of the laser beam used for drawing an image.

The image data calculation unit 62 calls the image data corresponding to a drawing pixel from the image data storage unit 60 based on the drawing timing information input from the drawing timing generation unit 61, performs various calculations, and sends brightness data of the respective colors out to a light source modulation unit 64. The light source modulation unit 64 adjusts the outputs of the laser light sources of the respective colors through light source drive circuits based on the brightness data corresponding to the respective colors of the first light source module 8 and the second light source module 9 input from the image data calculation unit 62. As illustrated in FIG. 9, a light source drive circuit 65 drives the red laser light source 22, a light source drive circuit 66 drives the green laser light source 24, and a light source drive circuit 67 drives the blue laser light source 25. Further, a light source drive circuit 68 drives the green laser light source 36, and a light source drive circuit 69 drives the red laser light source 37.

The swing angle calculation unit 63 calculates the oscillation angle of the mirror unit 40 of the light deflection unit 11 based on the drawing line information input from the drawing timing generation unit 61, determines a voltage to be applied to the mirror driving unit 41 by a drive circuit 70, and controls oscillation (swing angle) of the light deflection unit 11 based on the information.

An image-capture-unit control unit 71 controls the image capture unit 3 (for example, a CCD camera) based on the drawing timing information sent from the drawing timing generation unit 61. The image capture unit 3 detects the finger 7 (the operation executor), and the reflection light beam between the finger 7 and the image projection surface 5, to detect the movement of the finger 7 (the operation executor), captures a two-dimensional image of the operation executor 7 when detecting that the finger 7 is in contact with the image projection surface 5, and takes the information into a position information detection unit 72. In addition, in the position information detection unit 72, the information right after the operation executor 7 moves in the vertical direction or two-dimensional direction with respect to the image projection surface 5, once stops, and then the finger 7 comes in contact with the image projection surface 5 is taken into.

The drawing timing information storing unit 73 is configured to store the drawing line information sent out from the drawing timing generation unit 61, and to send out the information to a position information generating unit 74 each time. The position information generating unit 74 is configured to capture a two-dimensional image at the time of detecting that the finger 7 (the operation executor) is in contact with the image projection surface 5 by the position information detection unit 72, and to output information indicating a key of the keyboard image 6 to which the operation is performed as operation information in association with the drawing line information (scanning position information of the laser beam) of the drawing timing information storing unit 73.

The projection apparatus 1 according to the first embodiment described above performs a two-dimensionally scanning with a laser beam emitted from the first light source module 8 by the light deflection unit 11 and projects the projection image 6 on the image projection surface 5. Since the laser beam is a parallel beam, it is possible to project the projection image 6 clearly regardless of a distance from the projection apparatus 1 to the image projection surface 5. Then, when the reflection light beam from the operation executor 7 such as a finger positioning in the projection region of the projection image 6 is detected by the image capture unit 3 and the detected position of the operation executor 7 is associated with the drawing line information (scanning position information of the laser beam), it is possible to accurately detect a position of the projection image 6 at which the operation executor 7 is pointing. In addition, it is possible to determine a position of the projection image with which the operation executor 7 such as a finger is in contact based on the information from the image capture unit 3 and the information of the projection image 6.

Further, the first light source module 8 includes the red laser light source 22, the green laser light source 24, and the blue laser light source 25. For example, in a case where the wavelength of the red laser beam is 640 nm, the wavelength of the green laser beam is 515 nm, and the wavelength of the blue laser beam is 450 nm, since the laser beams of these colors are on a high level of color purity, it is possible to obtain a wide range of color reproducibility with respect to the input image signal.

Further, the first light source module 8 includes a plurality of laser light sources which emit laser beams having different wavelengths according to an image signal. Then, when laser beams emitted from the plurality of laser light sources are synthesized and emitted, and the reflection light beam of the laser beam from the operation executor 7 is detected by the image capture unit 3, it is possible to detect a plurality of detection targets (for example, plural fingers) by identifying the signal indicating a positional approach among detection signals at respective scanning of laser beams. Further, in the image capture unit 3, it is possible to identify whether or not the operation executor 7 and the image projection surface 5 are in contact with each other.

Further, the projection apparatus 1 of the embodiment is configured to capture an image of a contact position between the operation executor 7 and the image projection surface by the image capture unit 3, and can accurately detect a position of the operation executor 7 (for example, a finger) with respect to the projection image 6 (for example, the keyboard image) by associating the contact position and the drawing line information of the laser beam.

Further, the light deflection unit 11 of the embodiment has a MEMS structure of an electrostatic drive system which includes the mirror unit 40 and the mirror driving unit 41 to oscillate the mirror unit 40. Therefore, the oscillation (drive) of the mirror unit 40 can be realized according to the voltage applied to the mirror driving unit 41 (between the mirror-side comb-like electrode 45 and the first comb-like electrode 46 and between the second comb-like electrode 50 and the outer-frame-side comb-like electrode 51). Further, a drive amount between the mirror-side comb-like electrode 45 and the first comb-like electrode 46, and a drive amount between the second comb-like electrode 50 and the outer-frame-side comb-like electrode 51 can be detected by detecting electrostatic capacitance between the mirror-side comb-like electrode 45 and the first comb-like electrode 46, and electrostatic capacitance between the second comb-like electrode 50 and the outer-frame-side comb-like electrode 51. In other words, the swing angle of the mirror unit 40 can be detected. Therefore, based on the drive amount, a control unit 20 controls a voltage applied to the mirror driving unit 41, so that it is possible to control the oscillation (drive) with a high accuracy.

Further, the MEMS structure can be accurately manufactured with the utilization of a semiconductor manufacturing technology. With this MEMS structure, a scanning position (the swing angle of the mirror unit 40) of the laser beam can be accurately controlled, and furthermore it is excellent even in responsiveness. Therefore, it is possible to achieve miniaturization, low noise and low power consumption by employing the MEMS structure of an electrostatic drive system as the light deflection unit 11.

Further, the projection apparatus 1 of the embodiment can be provided with the second light source module 9 (the combining light source module) which is used by combination with the first light source module 8. The laser beam emitted from the first light source module 8 and the laser beam emitted from the second light source module 9 are combined by the multiplexing unit 10. With the use of the multiplexing unit 10, the laser beams emitted from the first light source module 8 and the second light source module 9 can be integrated into one optical flux, and thus the illuminance can be improved.

Further, in the embodiment, the second light source module 9 may incorporate an appropriate laser light source as needed. Therefore, a desired performance or function can be sufficiently exerted according to needs. For example, in a case where brightness is necessary, it is possible to employ a configuration in which two green laser light sources 36 are provided in the second light source module 9 as illustrated in FIG. 5. Further, it is possible to select and incorporate laser light sources which emit the laser beams having appropriate outputs and colors according to outputs or visible sensitivities of the laser light sources.

Further, the projection apparatus 1 of the embodiment may be configured such that an infrared laser light source which can emit the infrared laser is attached to any one of the first light source module 8 and the second light source module 9, instead of the red, green or blue laser light source. This infrared light source may be an infrared sensor equipped with the light receiving unit to receive the reflection light beam (specular reflection light beam) of the emitted infrared beam. The infrared light source is used for detecting a position of the operation executor 7 (for example, the finger 7) as a target with respect to the image projection surface 5 and the projection image 6 by receiving light in the light receiving unit. With the use of the infrared light source, it is possible to accurately detect the operation executor 7 in a case where the projection image is dark or a case where the contrast of the projection image is large.

Further, the projection image 6 of the embodiment is preferably formed in an operation pattern of an operation target device. The operation pattern illustrated in FIG. 1 is the keyboard image such as a virtual keyboard. In addition to the exemplified keyboard image, the operation pattern is applicable to an operation board pattern instead of an operation button of the operation target device, a key pattern instead of an entry management key of a room with high confidentiality, or the like. Since the operation pattern according to the embodiment is a projection image, at a position separated from the operation target device or a management target, the operation pattern is applicable to an operation panel which is used to input an operation command to the operation target device or the management target. Further, since the projection image is formed by scanning with a laser beam, a position of the image projection surface 5 is not limited, for example, to a desk as illustrated in FIG. 1, but the projection image may be projected on a position of a side wall or the operation target device in which operation is easily performed. In addition, a material or the like of the image projection surface is not limited, and the projection image may be projected to a white board, a screen, or the like. In such a case, a writing utensil such as a pen or a pointing stick may be applied as the operation executor.

Further, it is possible to change the arrangement or interval of the operation keys in the operation pattern projected as the projection image 6 may be modified by changing a program of the image signal. For example, a frequently-used operation key can be projected in a large size, and a space between the operation keys in which it is desired to prevent input mistakes can be set to be wide.

As described above, since the projection apparatus 1 of the embodiment has a function of projecting the projection image according to the image signal and identifying an operation behavior of the operation executor with respect to the projection image, it is preferable for various interactive devices.

### Second Embodiment

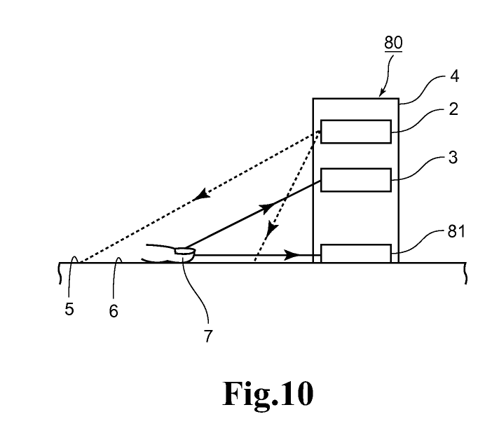

Next, a second embodiment of the invention will be described with reference to FIG. 10. A projection apparatus 80 of the second embodiment is provided with a second light detection unit 81 disposed near the image projection surface 5 in addition to the light detection unit 3 described in the first embodiment, and is configured to reliably detect the movement of the operation executor 7 such as a finger in the vertical direction with respect to the image projection surface 5 by the second light detection unit 81.

FIG. 10 is a diagram schematically illustrating the projection apparatus 80 according to the second embodiment of the invention. As illustrated in FIG. 10, the projection apparatus 80 includes the light source unit 2 having the first light source module 8 or the like, and the image capture unit 3 as the light detection unit similarly to the first embodiment (see FIG. 1), and further includes the second light detection unit 81 at a position near the image projection surface 5. The second light detection unit 81 is an image capture unit, for example, a CCD camera or the like. The second light detection unit 81 is disposed to capture an image of a space extending in substantially parallel to the image projection surface 5. In other words, the light detection unit 3 typically detects a position (movement) of the operation executor in the two-dimensional direction along the image projection surface 5, and the second light detection unit 81 is provided to detect the movement of the operation executor in the vertical direction with respect to the image projection surface 5.

In this way, the projection apparatus 80 of the second embodiment can reliably detect the movement of the operation executor 7 such as a finger in the vertical direction with respect to the image projection surface 5 by capturing the image of the space extending in substantially parallel to the image projection surface 5 by the second light detection unit 81. Accordingly, it is possible to reliably detect that the operation executor 7 is in contact with the image projection surface 5, and accurately detect a two-dimensional position with respect to the projection image 6 when the operation executor 7 is in contact with the image projection surface 5.

Hitherto, the projection apparatus 1 has been described in the respective embodiments of the invention, and various modifications can be made without departing from the scope of the invention. For example, the contact between the operation executor 7 and the image projection surface 5 may not be an actual contact, but it may be determined as “contact”, for example, when distance between the operation executor 7 and the image projection surface 5 becomes equal to or less than 3 mm. The value is preferably equal to or less than 5 mm, and more preferably equal to or less than 3 mm. As a range of the value, 0.1 mm to 5 mm is preferable, and 0.1 mm to 1 mm is more preferable.

In the respective embodiments described above, the optical components included in the first light source module 8, the second light source module 9, and the optical unit 39 are not limited to those described above, but various other components may be additionally or selectively used if necessary. Examples of such optical components include a mirror such as a half mirror and dichroic mirror, various types of lenses, various types of prisms, optical filters, and the like.

Further, in the respective embodiments described above, the second light source module 9 corresponds to the combining light source module, but the number of combining light source modules is not limited to “1”, and a plurality of combining light source modules may be employed. In such a case, the arrangement of the light source units may be equal or may be different in the plurality of combining light source modules. Further, a plurality of first light source modules 8 may be employed.

Further, in the respective embodiments described above, the light deflection unit 11 has been described about the MEMS structure of an electrostatic drive system in which the mirror unit 40 and the mirror driving unit 41 to oscillate the mirror unit 40 are included. However, the light deflection unit 11 is not limited to the electrostatic drive system of the MEMS type. As another light deflection unit, there is a metal-based optical scanning element employing a metal base structure of a piezoelectric drive type, and a piezoelectric system using a distortion of the piezoelectric element may be employed. Further, an electromagnetic system to drive the mirror unit by a magnetic force may be employed.

Further, in the projection apparatus 1, a posture control unit which switches the posture of projection apparatus 1 may be provided in the housing 4 to which the light source unit 2 and the light detection unit 3 are attached. With the configuration of the posture control unit, it is possible to change a direction of the laser beam emitted from the light source unit 2 with respect to an attachment surface to which the projection apparatus 1 is attached, and increase the flexibility in direction or position of the image projection surface 5 with respect to the projection apparatus 1. Further, the projection image 6 may be distorted (for example, becomes trapezoidal) in some cases depending on the positional relation between the light source unit 2 and the image projection surface 5. Thus, by adjusting an angle of the projection apparatus 1 relative to the image projection surface 5 with respect to an optical path (optical axis) of the light source unit 2 using the posture control unit, it is possible to perform correction (for example, so-called keystone correction) on the distortion of the projection image so as to form the projection image similar to the input image signal.

Further, in the second embodiment, the description has been made about the configuration in which the second light detection unit 81 is provided near the image projection surface 5, but the laser light source may be provided near the image projection surface 5. The laser light source is parallel to the image projection surface 5, and radically irradiates a space where the operation executor 7 is movable with the laser beam. When it is configured that the reflection light beam of the laser beam from the operation executor 5 is detected, it is possible to accurately detect the movement of the operation executor 7 in the vertical direction with respect to the image projection surface 5 (that is, whether the operation executor 7 is in contact with or separated from the image projection surface 5).

Further, the description has been made about that the light source module in the light source unit 2 includes the plurality of laser light sources having different wavelengths. However, the light source module may be configured by a light source module which includes one laser light source emitting the light beams having one or plural wavelengths. Further, in the respective embodiments described above, the image signal is input, but a simple signal may be input. In addition, the light source unit 2 and the image capture unit 3 may be placed in different housings, or the image capture unit 3 and the second light detection unit 81 may be placed in a compact and flat housing so as to be simply moved by the hand.

1. A projection apparatus comprising:
a light source module which includes a laser light source to emit a laser beam;
a light deflection unit which performs a two-dimensional scanning with the laser beam emitted from the light source module and projects a projection image on an image projection surface;
a light detection unit which detects a reflection light beam of the laser beam from an operation executor on the projection image; and
a control unit which determines a position of the projection image with which the operation executor is in contact based on information from the light detection unit and information from the projection image.

2. The projection apparatus according to claim 1, wherein
the light source module includes any one or all of a red laser light source, a green laser light source, and a blue laser light source.

3. The projection apparatus according to claim 1, wherein
the laser light source is formed by a plurality of laser light sources which emit laser beams different in wavelength according to an image signal, and the light source module synthesizes and emits the laser beams emitted from the plurality of laser light sources, and
the light detection unit is an image capture unit which captures an image of the operation executor.

4. The projection apparatus according to claim 1, wherein
the light detection unit detects a contact position between the operation executor and the image projection surface, and detects a position of the operation executor with respect to the projection image in association with the contact position and drawing line information of the laser beam.

5. The projection apparatus according to claim 1, wherein
the light deflection unit has a MEMS structure of an electrostatic drive system in which a mirror unit and a mirror driving unit to oscillate the mirror unit are included.

6. The projection apparatus according to claim 1, further comprising:
a combining light source module which emits the laser beam and is combined with the light source module; and
a multiplexing unit which synthesizes a laser beam emitted from the light source module and a laser beam emitted from the combining light source module.

7. The projection apparatus according to claim 1, wherein
the laser beam includes an infrared beam, and
the infrared light is constantly irradiated within the area of the projection image.

8. The projection apparatus according to claim 1, wherein
the projection image is an operation pattern of an operation target device.

9. The projection apparatus according to claim 1, further comprising:
in addition to the light detection unit,
a second light detection unit which is disposed near the image projection surface and detects movement of the operation executor in a vertical direction with respect to the image projection surface.
